(19) United States
(12) Patent Application Publication
(10) Pub. No.: US 2008/0052033 A1
(43) Pub. Date: Feb. 28, 2008

(54) Method, Apparatus and Computer Program Product of Aliasing Discriminator for Encoder Interfaces

(75) Inventor: Zachary Buckner, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: University of Virginia Patent Foundation, Charlottesville, VA (US)

(21) Appl. No.: 11/660,011

(22) PCT Filed: Aug. 12, 2005
(86) PCT No.: PCT/US05/28942

§ 371 Date: Feb. 9, 2007

Related U.S. Application Data
(60) Provisional application No. 60/601,043, filed on Aug. 12, 2004.

(51) Int. Cl. G01B 21/00

(52) U.S. Cl. 702/150

(57) ABSTRACT

An improved encoder interface system, able to track absolute position at higher encoder velocities without aliasing. The device and related apparatus, method and computer program product can perform this operation without loss of precision or accuracy. The improved encoder interface system can predict the phase angle of the signal for each sampling iteration and then measure the angular difference between the predicted phase angle and the actual phase angle to account for acceleration. The predictive capacity of the system thereby minimizes the problem of aliasing. As a result of this technique, aliasing will only occur when the acceleration of the object being observed exceeds a certain threshold that, like the Nyquist frequency, is dependent on the sampling rate of the signal acquisition component. Importantly, in most applications, this acceleration limit greatly exceeds any possible acceleration that the system will undergo.

### CROSS-REFERENCES TO RELATED APPLICATION

The present application claims priority from U.S. Provisional Patent Application Ser. No. 60/601,043, filed Aug. 12, 2004, entitled “Method, Apparatus and Computer Program Product of Aliasing Discriminator for Encoder Interfaces,” the disclosure of which is hereby incorporated by reference herein in its entirety.

The present Application is also related to PCT International Application No. PCT/US2004/039380, filed Nov. 22, 2004, entitled “Method and System for Enhanced Resolution, Automatically-calibrated Position Sensor,” the disclosure of which is hereby incorporated by reference herein in their entirety. The systems, methods and computer program products discussed herein may be utilized with the aforementioned PCT Application.

### BACKGROUND OF THE INVENTION

Encoders translate rotary or linear motion into electrical signals. These signals typically undergo several processing stages by the encoder interface before they are interpreted by control and measurement systems. The first stage within the encoder interface typically translates the sinusoidal signals into an instantaneous phase angle, modulo 2π:

$${θ}_{m} [ t ] = ( \frac{2 π}{interval} \times pos [ t ] ) \%2 π \qquad ( 1 )$$

where pos represents the instantaneous position to be measured, and interval represents the encoder distance that corresponds to a complete sinusoid period. The modulo limitation stems from the periodic nature of sinusoidal signals generated by the encoder. In digital systems, encoder signals are sampled with digital-to-analog converters, and a calculation is produced at regular time intervals Δt. Thus, the discrete variable t takes on integer values 0, 1, 2, . . . corresponding to the time instants 0·Δt, 1·Δt, 2·Δt, . . .

The second stage of the encoder interface typically tracks the instantaneous modulo phase angle in Equation 1 to produce an absolute phase, which is linearly related to the position:

$$θ [ t ] = \frac{2 π}{interval} \times pos [ t ] \qquad ( 2 )$$

A common approach for this second stage is to compare the difference between modulo phase values θₘ on successive time steps. Thus, at each time step, the following difference equations are evaluated:
θ[t]=θ[t−1]+ω[t] (3)
ω[t]=∠θₘ[t], θₘ[t−1] (4)
where ∠ is the “apparent motion” angular difference operator defined as

$$∠a 2 , a 1 = \{ \begin{matrix}a 2 - a 1 - 2 π & if a 2 - a 1 > π \\ a 2 - a 1 & if - π \leq a 2 - a 1 \leq π \\ a 2 - a 1 + 2 π & if a 2 - a 1 < - π\end{matrix} \qquad ( 5 )$$

and where θ[t] and w[t] relate to encoder position and velocity as follows:

$$\begin{matrix}position [ t ] = θ [ t ] \times \frac{interval}{2 π} & ( 6 ) \\ velocity [ t ] = w [ t ] \times \frac{interval}{Δ t \cdot 2 π} & ( 7 )\end{matrix}$$

The technique outlined in Equations 11 and 3 will correctly track absolute phase at sufficiently low angular velocities. However, since the angular difference operator can only produce values inside the range [−π, π], w[t] is constrained as
−π<w[t]<π (8)
Thus, by applying this constraint to Equation 7, it becomes

$$\vert velocity [ t ] \vert < \frac{interval}{2 \cdot Δ t} , \qquad ( 9 )$$

This inequality can be shown to identify the well-known Nyquist sampling frequency. In the case of a fixed sampling frequency (a technological limitation for circuits), this corresponds to a limited encoder velocity. If velocity exceeds this bound, a phenomenon known as aliasing will occur, causing erroneous results. Thus, the traditional method used for interfacing encoders has a severe drawback: limited operational speed.

### BRIEF SUMMARY OF THE INVENTION

Various embodiments of the present invention include, but are not limited thereto, an improved encoder interface component, able to track absolute position at higher encoder velocities without aliasing. The device and related apparatus, method and computer program product can perform this operation without loss of precision or accuracy.

As described in the Background above, existing encoder interfaces use a simple method to track absolute position that yields limited operational velocity. However, various embodiments of the present invention provide a new technique developed to overcome this limitation. The following difference equations describe aspects of the new approach:
θ[t]=θ[t−1]+w[t] (10)
w[t]=w[t−1]+a[t] (11)
a[t]=∠(θₘ[t]−θ_{predicted}[t]) (12)
θ_{predicted} [t]=(θₘ[t−1]+w[t−1])%2π (13)
subject to the initial conditions
θ[0]=w[0]=a[0]=0 (14)
where θₘ[t] is the measured phase input to the system, as described for Equation 1, and whereθ[t], w[t], and a[t] are calculated quantities that relate to encoder position, velocity, and acceleration as follows:

$$\begin{matrix}position [ t ] = θ [ t ] \times \frac{interval}{2 π} & ( 15 ) \\ velocity [ t ] = w [ t ] \times \frac{interval}{Δ t \cdot 2 π} & ( 16 ) \\ acceleration [ t ] = a [ t ] \times \frac{interval}{{( Δ t )}^{2} \cdot 2 π} & ( 17 )\end{matrix}$$

For each iteration, θ[t−1], θₘ[t−1] and w[t−1] are known, as they are the stored results from the previous iteration, and θₘ[t] is measured. The new algorithm uses the angular difference between the predicted phase, labeled θ_{predicted}, and the actual phase, labeled θₘ[t], to determine a[t], a step factor due to acceleration. The difference represents the change in position that is in excess of the predicted change, where the predicted change is based on the velocity from the previous iteration. In other words, the change in position for the current iteration is equal to the change in position for the previous iteration plus a[n], a measurable step factor due to acceleration.

The same rationale that limits maximum velocity in the traditional encoder scheme (as described in Equations 8 and 9) can be applied to the new technique. However, under the new technique, the limited range of the angular difference function limits only a[t]:
−π<a[t]<π (18)
By applying this constraint to Equation 17, it becomes:

$$acceleration [ t ] < \vert \frac{interval}{2 \cdot {( Δ t )}^{2}} \vert \qquad ( 19 )$$

Thus, the original velocity constraint has been replaced with an acceleration constraint. In most applications, this acceleration limit greatly exceeds any possible acceleration that the system could undergo.

An aspect of an embodiment of the present invention system provides for detecting motion from a sensor interface. The system comprising: a signal acquisition means for acquiring an instantaneous phase during each iteration received from the sensor interface; a phase register means for holding the instantaneous phase from the previous iteration that is acquired by the signal acquisition means; an output register means for holding the instantaneous angular velocity output from the previous iteration that is acquired by the signal acquisition means; a phase predictor means for predicting a phase that will result from the current sensing iteration; a phase subtractor means for determining amount of angular movement for the current iteration relative to the predicted phased angle; an overflow corrector means for correcting erroneous overflow/underflow condition; and a final adder means for computing total velocity for the current iteration.

An aspect of an embodiment of the present invention method provides for detecting motion from a sensor interface. The method comprising: acquiring an instantaneous phase received from the interface; holding the instantaneous phase acquired by the acquisition step for the current iteration; holding the instantaneous phase acquired by the acquisition step for the previous iteration; holding the computed velocity output from the previous iteration; predicting a phase that will result from the current sensing iteration; determining amount of angular movement for the current iteration relative to the predicted phased angle; correcting possible overflow/underflow conditions; and computing output velocity for the current iteration relative to the position for the previous iteration.

An aspect of an embodiment of the present invention computer program product comprises a computer useable medium having computer program logic for enabling at least one processor in communication with an interface motion detection system. The computer program logic comprising: acquiring an instantaneous phase received from the interface system; holding the instantaneous phase acquired by the acquisition step for the current iteration; holding the instantaneous phase acquired by the acquisition step for the previous iteration; holding the computed velocity output from the previous iteration; predicting a phase that will result from the current sensing iteration; determining amount of angular movement for the current iteration relative to the predicted phased angle; correcting possible overflow/underflow conditions; and computing output velocity for the current iteration relative to the position for the previous iteration.

These and other aspects of the disclosed technology and systems, along with their advantages and features, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 is a schematic diagram, showing an interface and the signal processing components of an embodiment of the present invention in block form.

### DETAILED DESCRIPTION OF THE INVENTION

The various embodiments of the present invention provide for, but are not limited thereto, an improved encoder interface system, able to track absolute position at higher encoder velocities without aliasing (as well as operating at slower velocities if desired). The device and related apparatus, method and computer program product can perform this operation without loss of precision or accuracy. The improved encoder interface system can predict the phase angle of the signal for each sampling iteration and then measure the angular difference between the predicted phase angle and the actual, measured phase angle to account for acceleration. The predictive capacity of the system thereby minimizes the problem of aliasing. As a result of this technique, aliasing will only occur when the acceleration of the object being observed exceeds a certain threshold that, like the Nyquist frequency, is dependent on the sampling rate of the signal acquisition component. Importantly, in most applications, this acceleration limit greatly exceeds any possible acceleration that the system will undergo.

This section provides a detailed description of a hardware implementation of various embodiments of the present invention. A software implementation (along with the apparatus and method) is also possible, and is described in the next section. In addition to these alternatives, there is a wide variety of possible configurations. The various embodiments of the present invention could be integrated directly within an encoder housing, integrated within an encoder interface, built as a separate component, or implemented on a personal computer.

For example, an embodiment of the present invention may comprise software, running on a computer or the like with analog-to-digital conversion circuitry, sampling data from its input. An embodiment of the present invention may comprise software, running on a microcontroller or digital signal processor with analog-to-digital conversion circuitry, sampling data from its input. An embodiment of the present invention may comprise discrete digital electronic components including an analog-to-digital converter. These components would be controlled using a field programmable gate array (or other programmable digital logic device like a PAL or PLC), sampling data from its input. An embodiment of the present invention may comprise discrete analog electronic components. These components would be controlled using a field programmable gate array (or other programmable digital logic device like a PAL or PLC), sampling data from its input. It should be appreciated that in any of the embodiments discussed herein the input may be received from any one of or any combination of the following: i) linear encoder, ii) rotary encoder, iii) stroboscope with imaging circuitry, iv) interferometer, v) other sensor with quadrature output or other devices sensing position, angle and/or displacement (or any combination of sensing position, angle and/or displacement).

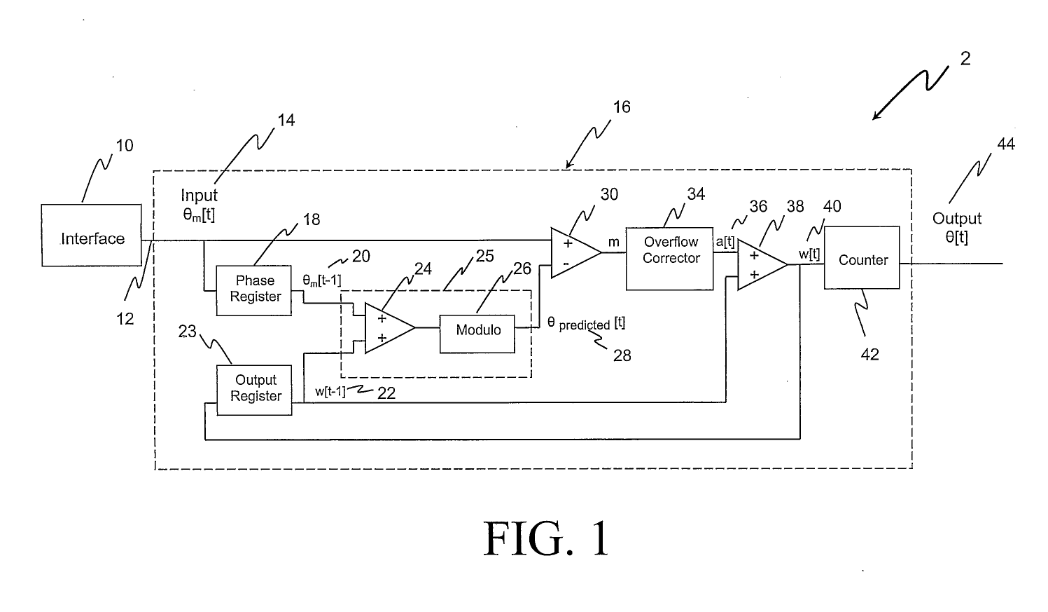

An embodiment of the present invention device may include the following parts, which correspond to elements in the exemplary System Diagram in FIG. 1.

Phase Input

This signal 12 represents the instantaneous phase of the encoder 10. It is assumed to be an unsigned discrete signal with values ranging from about 0 to (resolution−1), where the variable resolution is an arbitrary constant that will be referenced throughout the document. Other analog or digital signals could be simply converted to this format through the use of analog to digital converters and linear scaling. The instantaneous phase at time step n is indicated as θₘ[t], and referenced as 14, in FIG. 1.

Digital Controller

The digital controller 16 (or other select type of controller) manages the flow-of-control for all of the components in the System Diagram, as it connects to each component or select components of the system 2.

For an exemplary prototype, the controller may include an MSP430 Mixed Signal Processor manufactured by Texas Instruments. However, it should be appreciated that many other configurations are possible. One promising alternative is to make some or all of the components within the box separate, discrete components, and to control the flow-of-control using a finite state machine on an FPGA.

Phase Register

The output 20 of the phase register 18 holds the phase value from the previous discrete time step. The triggering of this component is timed by the digital controller 16. If implemented as separate digital logic components, this component may consist of two registers in series (the first stage to keep the input signal from changing during a single iteration, and the second stage to maintain the phase from the previous iteration). The output 20 of the phase register is labeled θₘ[t−1] in FIG. 1.

Output Register

The output 22 of the phase register 23 holds the output value from the previous time step. The triggering of this component is timed by the digital controller 16. If implemented as separate digital logic components, this component may consist of two registers in series (the first stage to keep the input signal from changing during a single iteration, and the second stage to maintain the phase from the previous iteration). The output 20 of the phase register is labeled w[t−1] in FIG. 1.

Phase Predictor

The phase predictor 25 uses the phase from the previous iteration, θₘ[t−1], and the total movement from the previous iteration, w[t−1], as referenced as 22, to predict the phase that will result from the current sensing iteration (i.e., the computed θ_{predicted}[t], as referenced as 28, which shall be discussed below). The phase predictor consists of an adder 24 and a modulo division unit 26, and yields the following behavior indicated in Equation 13, i.e., θ_{predicted}[t], as referenced as 28.

Phase Subtractor

This phase subtractor component 30 determines the amount of angular movement for the current iteration, relative to the predicted phase angle. This movement is simply the difference between the actual phase value, θₘ[t], and the phase value for the phase predictor, θ_{predicted}[t]. The resulting digital output from this component is the signal labeled m, as referenced as 32, in FIG. 1.

Overflow Corrector

Phase angle transitions from about 359° to about 0° or from about 0° to about 359° yield an apparent movement of about −359° or about 359°, respectively, though an actual movement of only about 1° or about −1°, respectively. The following technique as provided by the overflow corrector 34 corrects this type of erroneous overflow/underflow condition:

$$a [ t ] = \{ \begin{matrix}m - resolution , & if m > resolution / 2 \\ m + resolution , & if m < - resolution / 2 \\ m , & else\end{matrix} \qquad ( 20 )$$

The combination of the phase subtractor 30 and the overflow corrector 34 implement the “angular difference function.”

Adder

The final adder 38 in FIG. 1 is used to compute w[t], as referenced as 40, which is proportional to velocity for the current iteration. The operation parallels Equation 11.

Counter

The counter 42 is a register-based component that counts w[t] values for successive iterations. This operation parallels Equation 10. This counter 42 produces the system output 44 for the invention, and represents the absolute phase.

Turning to a software aspect, the following is C source code to describe an exemplary software implementation of an exemplary embodiment of the present invention and which the software functions provided below is copyrighted by the assignee:

```
// Initialize
absolutePhase = 0;
lastPhase = 0;
lastDeltaPos = 0;
// Infinite Loop
while (TRUE) {
  // Read the current phase (this corresponds to signal ‘thatam[t]’
  // in the System Diagram.
  currentPhase = readPhaseInput( );
  // Determine the predicted phase (this corresponds to signal
  // ‘theta.predicted[t]’ in the system diagram). Note that ‘%’ is
  // the modulo division operator, and the constant ‘resolution’ is
  // defined in disclosure text.
  preclictedPhase = (lastPhase + lastDeltaPos) % resolution;
  // Determine the component due to acceleration (this corresponds to
  // signal ‘m’ in the System Diagram).
  deltaDeltaPos = currentPhase − predictedPhase;
  // Check for overflow or underflow (the output of this operation
  // corresponds to signal ‘a[t]’ in the System Diagram).
  if (deltaDeltaPos > (resolution / 2)) {
    deltaDeltaPos = deltaDeltaPos − resolution;
  } else if (deltaDeltaPos < −(resolution / 2)) {
    deltaDeltaPos = deltaDeltaPos + resolution;
  }
  // Determine the total change in position for the current timestep
  // (this corresponds to signal ‘w[t]’ in the system diagram).
  currentDeltaPos = lastDeltaPos + deltaDeltaPos;
  // Generate absolute phase, the output (this corresponds to signal
  // ‘theta[t]’ in the system diagram
  absolutePhase = absolutePhase + currentDeltaPos;
  // Prepare for the next iteration (this corresponds to triggering
  // the “Phase Register” and “Output Register” in the System Diagram).
  lastDeltaPos  = currentDeltaPos;
  lastPhase  = currentPhase;
}
```

It should be appreciated that the method of present invention may be implemented using hardware, software or a combination thereof and may be implemented in one (or with) or more computer systems, processors, controllers or other processing systems. Further, the computer system may include a display interface that forwards graphics, text, and other data from the communication infrastructure. The computer system also includes a main memory, preferably random access memory (RAM), and may also include a secondary memory. The secondary memory may include, for example, a hard disk drive and/or a removable storage drive, representing a floppy disk drive, a magnetic tape drive, an optical disk drive, a flash memory etc. The removable storage drive reads from and/or writes to a removable storage unit in a well known manner. Removable storage unit, represents a floppy disk, magnetic tape, optical disk, etc. which is read by and written to by removable storage drive. As will be appreciated, the removable storage unit includes a computer usable storage medium having stored therein computer software and/or data. In alternative embodiments, secondary memory may include other means for allowing computer programs or other instructions to be loaded into computer system. Such means may include, for example, a removable storage unit and an interface. Examples of such removable storage units/interfaces include a program cartridge and cartridge interface (such as that found in video game devices), a removable memory chip (such as a ROM, PROM, EPROM or EEPROM) and associated socket, and other removable storage units and interfaces which allow software and data to be transferred from the removable storage unit to computer system. Computer system may also include a communications interface. Communications interface allows software and data to be transferred between computer system and external devices. Examples of communications interface may include a modem, a network interface (such as an Ethernet card), a serial or parallel communications port, a PCMCIA slot and card, a modern etc. Software and data transferred via communications interface are in the form of signals, which may be electronic, electromagnetic, optical or other signals capable of being received by communications interface. Signals are provided to communications interface via a communications path (i.e., channel). A channel (or any other communication means or channel disclosed herein) carries signals and may be implemented using wire or cable, fiber optics, a phone line, a cellular phone link, an RF link, an infrared link and other communications channels. In this document, the terms “computer program medium” and “computer usable medium” are used to generally refer to media such as removable storage drive, a hard disk installed in hard disk drive, and signals. These computer program products are means for providing software to computer system. The various embodiments of the present invention include such computer program products. Computer programs (also called computer control logic) are stored in main memory and/or secondary memory. Computer programs may also be received via communications interface. Such computer programs, when executed, enable computer system to perform the features of the present invention as discussed herein. In particular, the computer programs, when executed, enable processor to perform the functions of the present invention. Accordingly, such computer programs represent controllers of computer system. In an embodiment where the invention is implemented using software, the software may be stored in a computer program product and loaded into computer system using removable storage drive, hard drive or communications interface. The control logic (software), when executed by the processor, causes the processor to perform the functions of the invention as described herein. In another embodiment, the invention may be implemented primarily in hardware using, for example, hardware components such as application specific integrated circuits (ASICs). Implementation of the hardware state machine to perform the functions described herein will be apparent to persons skilled in the relevant art(s). In yet another embodiment, the invention is implemented using a combination of both hardware and software. In an example software embodiment of the invention, the methods described above may be implemented in various programs and programming language known to those skilled in the art.

The various embodiments of the present invention system and method may be utilized for a variety of interfaces, functions, purposes, methods and systems including as discussed in the following patents and publications listed below and of which are hereby incorporated by reference herein in their entirety:

U.S. Pat. No. 6,630,659 B1 to Stridsberg, entitled “Position Transducer”;

U.S. Pat. No. 6,573,710 B1 to Santos et al., entitled “Position and/or Displacement Sensor Including a Plurality of Aligned Sensor Elements”;

U.S. Pat. No. 6,556,153 B1 to Cardamone, entitled “System and Method for Improving Encoder Resolution”;

U.S. Pat. No. 6,459,261 B1 to Luetzow et al., entitled “Magnetic Incremental Motion Detection System and Method”;

U.S. Pat. No. 6,456,063 B1 to Moreno et al., entitled “Self Compensating Control Circuit for Digital Magnetic Sensors”;

U.S. Pat. No. 6,294,910 B1 to Travostino et al., entitled “Digital Position Sensor for Sensing Position of a Moving Target”;

U.S. Pat. No. 6,232,739 B1 to Krefta et al., entitled “High-Resolution Incremental Position Sensor With Pulse Switching Strategy”;

U.S. Pat. No. 6,191,415 B1 to Stridsberg, entitled “Position Transducer”;

U.S. Pat. No. 6,172,359 B1 to Stridsberg, entitled “Position Transducer”;

U.S. Pat. No. 6,084,234 to Stridsberg, entitled “Position Transducer”;

U.S. Pat. No. 5,719,789 to Kawamata, entitled “Method of and Apparatus for Detecting an Amount of Displacement”;

U.S. Pat. No. 5,442,313 to Santos et al., entitled “Resolution Multiplying Circuit”;

U.S. Pat. No. 5,067,089 to Ishii et al., entitled “Device Having Signal Interpolation Circuit and Displacement Measuring Apparatus Comprising the Device”;

U.S. Pat. No. 5,041,784 to Griebeler, entitled “Magnetic Sensor With Rectangular Field Distorting Flux Bar”;

U.S. Pat. No. 5,012,239 to Griebeler, entitled “High Resolution Position Sensor Circuit”;

U.S. Pat. No. 4,972,080 to Taniguchi, entitled “Signal Processing Apparatus for Pulse Encoder With A/D Conversion and Clocking”;

U.S. Pat. No. 4,630,928 to Klingler et al., entitled “Length Measuring Device”;

U.S. Pat. No. 4,587,485 to Papiernik, entitled “Evaluation Arrangement for a Digital Incremental Transmitter”;

U.S. Pat. No. 3,956,973 to Pomplas, entitled “Die Casting Machine With Piston Positioning Control;” and

Z. Buckner, “Enhanced Resolution Quadrature Encoder Interface,” master's thesis, Department of Electrical and Computer Engineering, University of Virginia, Charlottesville, 2004.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would tender invalid any claim herein or seeking priority hereto, then any such conflicting information in such incorporated by reference material is specifically not incorporated by reference herein.

We claim:

1. A system for detecting motion from a sensor interface, said system comprising:
a signal acquisition means for acquiring an instantaneous phase during each iteration received from said sensor interface;
a phase register means for holding the instantaneous phase from the previous iteration that is acquired by said signal acquisition means;
an output register means for holding the instantaneous angular velocity output from the previous iteration that is acquired by said signal acquisition means;
a phase predictor means for predicting a phase that will result from the current sensing iteration;
a phase subtractor means for determining amount of angular movement for the current iteration relative to the predicted phased angle;
an overflow corrector means for correcting erroneous overflow/underflow condition; and
a final adder means for computing total velocity for the current iteration.

2. The system of claim 1, wherein absolution position, angle, or motion, or any combination thereof, is accumulated by a counter means.

3. The system of claim 2, wherein the instantaneous phase of the input at time step n is indicated as θₘ[t].

4. The system of claim 3, wherein output said phase register is indicated as θₘ[t−1].

5. The system of claim 4, wherein said phase predictor means comprises using the previous iteration, as indicated as θₘ[t−1], and the total movement from the previous iteration, as depicted as w[t−1], to predict the phase that will result from the current sensing iteration.

6. The system of claim 5, wherein the amount of angular movement for the current iteration, relative to the predicted phase is determined by the difference between the actual phase value, as indicated as θₘ[t], and the phase value for the phase predictor, as indicated as θ_{predicted}[t],
wherein, the resulting digital output from this component is the signal as indicated as m.

7. The system of claim 6, wherein the overflow/underflow condition is determined according the following formula:
$$a [ t ] = \{ \begin{matrix}m - resolution , & if m > resolution / 2 \\ m + resolution , & if m < - resolution / 2 \\ m , & else .\end{matrix} \qquad ( 1 )$$

8. The system of claim 7, wherein the computed velocity relative to the position or angle from the previous iteration is reflected by w[t].

9. The system of claim 8, wherein said counter means counts w[t] values for successive iterations to provide the actual, absolute phase or position as reflected as θₘ[t].

10. The system of claim 2, wherein said counter means comprises at least one of a summing apparatus and/or an accumulator apparatus.

11. The system of claim 1, wherein said signal acquisition means comprises an analog to digital converter.

12. The system of claim 1, wherein said signal acquisition means and the sensor interface are integral with one another.

13. The system of claim 1, wherein said phase predictor means comprises an adder means and a modulo division unit means.

14. The system of claim 1, wherein said sensor interface comprises at least one of linear encoder, rotary encoder, stroboscope with imaging circuitry, interferometer, other sensor with quadrature output or other devices sensing position, angle and/or displacement, or any combination thereof.

15. The system of claim 1, further comprising a controller in communication with the system.

16. The system of claim 15, wherein said controller comprises a computer controller.

17. A method for detecting motion from a sensor interface, said method comprising:
acquiring an instantaneous phase received from the interface;
holding the instantaneous phase acquired by said acquisition step for the current iteration;
holding the instantaneous phase acquired by said acquisition step for the previous iteration;
holding the computed velocity output from the previous iteration;
predicting a phase that will result from the current sensing iteration;
determining amount of angular movement for the current iteration relative to the predicted phased angle;
correcting possible overflow/underflow conditions; and
computing output velocity for the current iteration relative to the position for the previous iteration.

18. The method of claim 17, wherein said sensor interface accumulates absolute or actual phase based on the velocity outputs from successive iterations.

19. The method of claim 17, wherein said sensor interface comprises at least one of linear encoder, rotary encoder, stroboscope with imaging circuitry, interferometer, other sensor with quadrature output or other devices sensing position, angle and/or displacement, or any combination thereof.

20. The method of claim 17, further comprising a computer controller adapted to control at least some of the steps listed in claim 17.

21. A computer program product comprising a computer useable medium having computer program logic for enabling at least one processor in communication with an interface motion detection system, said computer program logic comprising:
acquiring an instantaneous phase received from said interface system;
holding the instantaneous phase acquired by said acquisition step for the current iteration;
holding the instantaneous phase acquired by said acquisition step for the previous iteration;
holding the computed velocity output from the previous iteration;
predicting a phase that will result from the current sensing iteration;
determining amount of angular movement for the current iteration relative to the predicted phased angle;
correcting possible overflow/underflow conditions; and
computing output velocity for the current iteration relative to the position for the previous iteration.

22. The computer program product of claim 21, wherein said interface accumulates absolute or actual phase based on velocity outputs from successive iterations.

23. The computer program product of claim 21, wherein said interface motion detection system comprises at least one of linear encoder, rotary encoder, stroboscope with imaging circuitry, interferometer, other sensor with quadrature output or other devices sensing position, angle and/or displacement, or any combination thereof.
